(19) United States
(12) Patent Application Publication
(10) Pub. No.: US 2009/0154672 A1
(43) Pub. Date: Jun. 18, 2009

(54) PATH SETTING METHOD OF INTEGRATED SWITCH FOR SIMULTANEOUSLY PROVIDING REAL-TIME MOBILITY OF IP ADDRESS AND TELEPHONE NUMBER

(75) Inventors: Sungsoo KANG, Daejeon-city (KR); Choon Sik Yim, Daejeon-city (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon-city (KR)

(21) Appl. No.: 12/100,171

(22) Filed: Apr. 9, 2008

(30) Foreign Application Priority Data
Dec. 17, 2007 (KR) 10-2007-0132594

(51) Int. Cl. H04M 11/00

(52) U.S. Cl. 379/93.09

(57) ABSTRACT

Provided is a path setting method of an integrated switch for simultaneously providing real-time mobility of an IP address and a telephone number. The path setting method of an integrated switch constructs an information pair of the telephone number and the IP address and transmits a voice call and a data packet using a home agent (HA) and a foreign agent (FA) for providing mobility in a mobile network easily and rapidly when a telephone terminal and an IP data terminal are moved. According to the path setting method of an integrated switch, the telephone terminal and the IP data terminal can use original addresses thereof when the telephone terminal and the IP data terminal are moved to a network area having a number system different from that of the network area to which the telephone terminal and the IP data terminal originally belong.

### CROSS-REFERENCE TO RELATED PATENT APPLICATION

This application claims the benefit of Korean Patent Application No. 10-2007-0132594, filed on Dec. 17, 2007, in the Korean Intellectual Property Office, the disclosure of which is incorporated herein in its entirety by reference.

### BACKGROUND OF THE INVENTION

1. Field of the Invention

The present invention relates to a path setting method of an integrated switch for simultaneously providing real-time mobility of an IP address and a telephone number and, more particularly, to a method for processing transmission of voice calls and data packets easily and rapidly using a home agent (HA) and a foreign agent (FA) for providing mobility in mobile communication and providing real-time mobility of an IP address and a telephone number.

According to the path setting method of an integrated switch of the present invention, an IP data terminal and a telephone terminal can use the original addresses thereof even when the IP data terminal and the telephone terminal are moved to a network area having a number system different from that of the network area to which the IP data terminal and the telephone terminal originally belong.

This work was supported by the IT R&D program of MIC/IITA[2005-S-038-03, UHF RF-ID and Ubiquitous networking technology development].

2. Description of the Related Art

A system and a method for fast hand-off in a mobile network using a mobile stream control transmission protocol have been proposed as a method for providing IP mobility. In this system and method, when a mobile node recognizes necessity for hand-off, the mobile node receives a routing advertisement message of a connection router adjacent to an arbitrary connection router in the area having the arbitrary connection router and finds an IP address that can be used in the area of the adjacent connection router. When the mobile node generates the IP address before moved to the adjacent router area, the mobile node uses the previously generated IP address. However, the method for fast hand-off is limited to IP data terminals for streaming transmission and cannot be applied to mobile number portability.

Furthermore, a conventional method for providing mobility of a mobile terminal informs L3 layer (network layer) of generation of hand-off and information of a link layer when propagation signal intensity of the link layer is reduced to a predetermined level in order to process fast hand-off. In this method, a mobile terminal is authenticated before hand-off is generated in the L3 layer. Accordingly, the method is applied to only a mobile terminal having this function and cannot be applied to telephone number portability.

Moreover, there is a method of providing mobility using mobile phone roaming according to global system roaming mobile telecommunication (GSM). However, this method cannot provide phone number portability service in a general mobile phone or wire telephone exchange which does not use GSM and IP data packet mobility.

Furthermore, a method of providing person information mobility in a fixed wired network instead of terminal mobility in a mobile telephone network or a mobile IP network was proposed. That is, when a telephone user moves to an area (area B) such as a foreign country, selects a specific terminal in the area and registers a telephone number of an area (area A) where the user subscribes for telephone service and information on service details at the area B through the specific terminal, the user can be provided with the same telephone service as the telephone service provided in the area A.

In the method of providing person information mobility in a fixed wired network, however, the user has to input his information in order to receive the service in the visiting area and real-time mobility for voice call and IP packet data integrated service is not provided.

Moreover, a method of enabling originating and terminating of calls even when calls are connected through various types of networks including a wired network and a mobile network using a voice gateway such as a soft switch was proposed. However, this is a kind of roaming method in which a terminal is previously registered at a database of the voice gateway to be provided with a service and the method cannot provide real-time mobility.

The aforementioned conventional methods are limited to the mobile phone roaming service and a case that a destination area is informed of a mobile terminal and approves the mobile terminal to provide a roaming service to the mobile terminal. Furthermore, the conventional methods cannot provide real-time simultaneous mobility of a telephone terminal and an IP data terminal.

### SUMMARY OF THE INVENTION

The present invention provides a path setting method of an integrated switch for processing transmission of voice calls and data packets easily and rapidly using a home agent (HA) and a foreign agent (FA) for providing mobility in mobile communication and providing real-time mobility of an IP address and a telephone number.

According to an aspect of the present invention, there is provided a method of providing services to terminals using an integrated switch, the method including: transmitting an identifier of a telephone terminal of a subscriber in response to an identifier request signal received from the integrated switch and receiving a telephone service from the integrated switch through the telephone terminal; detecting a silent period from a telephone service channel of the telephone terminal; and transmitting an IP service registration request message including a care-of-address (CoA) using the silent period of the telephone service channel to the integrated switch, receiving a registration response message including an approval response from the integrated switch, and receiving an IP data terminal service from the integrated switch through a data terminal of the subscriber.

According to another aspect of the present invention, there is provided a path setting method of an integrated switch for simultaneously providing real-time mobility of an IP address and a telephone number, the path setting method comprising: receiving a registration request message including a telephone number of a telephone terminal and an IP address of an IP data terminal from a first integrated switch located in a first network area in which the telephone terminal and the IP data terminal are originally located when the telephone terminal and the IP data terminal are moved to a second network area; determining whether the telephone number of the telephone terminal and the IP address of the IP data terminal are included in an internal list of a second integrated switch located in the second network area; and providing the telephone service to the telephone terminal by the second integrated switch and providing the IP data service to the IP data terminal in a silent period of a telephone service channel of the telephone terminal when the telephone number of the telephone terminal and the IP address of the IP data terminal both are included in the internal list of the second integrated switch.

According to the path setting method of an integrated switch, a telephone terminal and an IP data terminal can use original addresses thereof when the telephone terminal and the IP data terminal are moved to a network area having a number system different from that of the network area to which the telephone terminal and the IP data terminal originally belong.

The path setting method of an integrated switch according to the present invention can be applied to mobile phones as well as wire telephones.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a structure of an integrated switch network simultaneously providing real-time mobility of a single IP address and a single telephone number according to an embodiment of the present invention;

FIG. 2 illustrates configurations of a mobile phone and an IP data terminal according to an embodiment of the present invention;

FIG. 3 is a flow chart illustrating the operation of the mobile phone illustrated in FIG. 2 according to an embodiment of the present invention;

FIG. 4 is a flow chart illustrating the operation of the IP data terminal illustrated in FIG. 2 according to an embodiment of the present invention;

FIG. 5 illustrates lists included in an internal agent of an integrated switch according to an embodiment of the present invention;

FIG. 6 illustrates details of a list of terminals belonging to an integrated switch according to an embodiment of the present invention;

FIG. 7 illustrates details of a relay list of the integrated switch according to an embodiment of the present invention;

FIG. 8 illustrates details of a visitor list of the integrated switch according to an embodiment of the present invention;

FIG. 9 illustrates details of a neighboring area list of the integrated switch according to an embodiment of the present invention;

FIG. 10A, 10B and 10C are a flow chart illustrating an operation of an integrated switch to which a telephone terminal and an IP data terminal originally belong for processing a mobility-related message from another integrated switch to which the telephone terminal and the IP data terminal are connected;

FIG. 11 is a flow chart illustrating an operation of processing a mobility-related message when a telephone terminal that does not belong to an integrated switch A is connected to the integrated switch A to be provided with a service;

FIG. 12 is a flow chart illustrating an operation of an integrated switch geographically adjacent to an integrated switch A when a telephone terminal and an IP data terminal which do not belong to the integrated switch A is connected to the integrated switch A to be provided with a service;

FIG. 13 illustrates a format of a registration request message transmitted from an IP data terminal to an integrated switch, which corresponds to IETF RFC3344 format; and

FIG. 14 illustrates a format of a registration response message transmitted from an integrated switch to an IP data terminal, which corresponds to IETF RFC3344 format.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those of ordinary skill in the art. Throughout the drawings, like reference numerals refer to like elements.

A path setting method of an integrated switch for simultaneously providing real-time mobility of an IP address and a telephone number according to the present invention constructs an information pair of the telephone number and the IP address and transmits a voice call and a data packet using a home agent (HA) and a foreign agent (FA) for providing mobility in a mobile network easily and rapidly when a telephone terminal and an IP data terminal are moved.

The path setting method of an integrated switch according to the present invention can be applied to mobile phones as well as wire telephones.

According to the path setting method of an integrated switch, a telephone terminal and an IP data terminal can use original addresses thereof when the telephone terminal and the IP data terminal are moved to a network area having a number system different from that of the network area to which the telephone terminal and the IP data terminal originally belong.

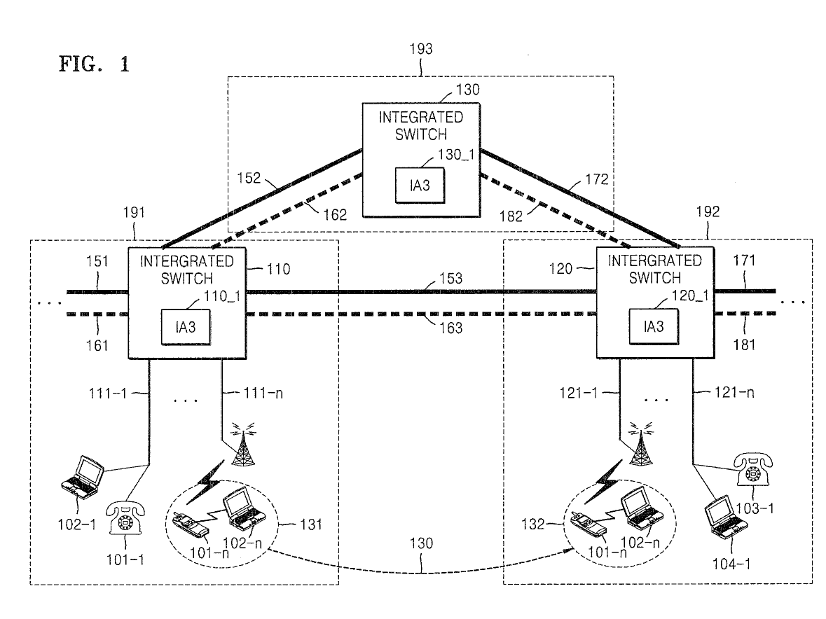

FIG. 1 illustrates a structure of an integrated switch network for simultaneously providing real-time mobility of a single IP address and a single telephone number according to an embodiment of the present invention.

Integrated switches 110, 120 and 130 which provide real-time simultaneous mobility of an IP address and a telephone number use common channel interoffice signaling (CCIS) to process signals of voice phones and use a virtual private network separated from a data path as a signal packet path for IP handoff.

Each integrated switch can process data in a silent period of a telephone channel. The integrated switch 110 is connected to subscriber lines 111-1 through 111-n. The subscriber line 111-1 is connected to a wire telephone 101-1 and a data terminal 102-1, and thus data is transmitted from the data terminal 102-1 to the integrated switch 110 through the subscriber line 111-1 in a silent period of a user while the user is speaking over the wire telephone 101-1. The subscriber line 111-n is connected to a mobile phone 101-n and a data terminal 102-n, and thus data is transmitted from the data terminal 102-n to the integrated switch 110 through the subscriber line 111-n in a silent period of a user while the user is talking over the mobile phone 101-n. While it is required to connect a device for air interface with the mobile phone 101-n to the end of the subscriber line 111-n, the device is omitted in FIG. 1 for convenience of explanation.

The integrated switch 120 includes subscriber lines 121-1 through 121-n. The subscriber line 121-n is connected to a wire telephone 103-1 and a data terminal 104-1, and thus data is transmitted from the data terminal 121-n to the integrated switch 120 through the subscriber line 121-n in a silent period of a user while the user is talking over the wire telephone 103-1. The integrated switch 130 includes the same subscriber lines as those of the integrated switches 110 and 120.

Bold solid lines 151, 152, 153, 171 and 172 between neighboring integrated switches represent telephone trunks and bold dotted lines 161, 162, 163, 181 and 182 between neighboring integrated switches denote data trunks. The telephone trunk 153 and the data trunk 163 respectively connect a telephone call and data between the integrated switches 110 and 120 and the telephone trunk 152 and the data trunk 162 respectively connect a telephone call and data between the integrated switches 110 and 130. The telephone trunk 173 and the data trunk 182 respectively connect a telephone call and data between the integrated switches 120 and 130. The telephone trunk 151 and the data trunk 161 respectively connect a telephone call and data between the integrated switches 110 and an integrated switch (not shown) located on the left of the integrated switch 110, and the telephone trunk 171 and the data trunk 181 respectively connect a telephone call and data between the integrated switches 120 and an integrated switch (not shown) located on the right of the integrated switch 120.

Reference numerals 191, 192 and 193 represent areas covered by the integrated switches 110, 120 and 130, respectively, and reference numerals IA1 (110-1), IA2 (120-1) and IA3 (130-1) denote integrated agents for supporting real-time mobility of voice calls and data in the integrated switches 110, 120 and 130, respectively.

Furthermore, a dotted line 131 represents a pair of the mobile phone 101-n and the data terminal 102-n sharing the same subscriber line 111-n of the integrated switch 110 and a dotted line 132 represents a pair of the mobile phone 101-n and the data terminal 102-n sharing the same subscriber line 121-1 of the integrated switch 120.

An arrow 130 represents the movement of the mobile phone 101-n and the data terminal 102-n from the area 191 of the integrated switch 110 and the area 192 of the integrated switch 120. The mobile phone 101-n and the data terminal 102-n in the pair 131 are identical to the mobile phone 101-n and the data terminal 102-n in the pair 132.

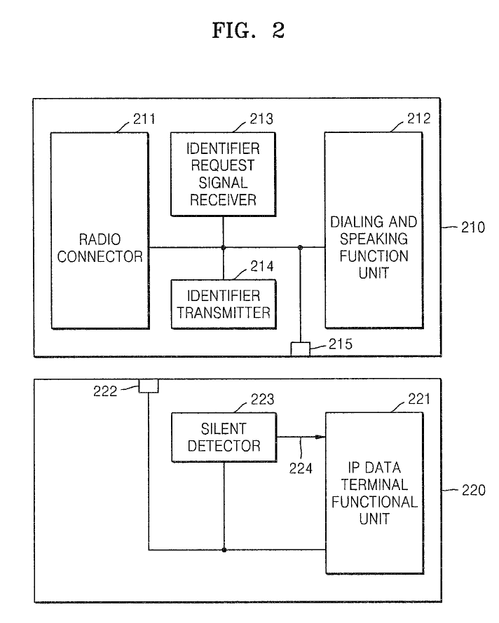

FIG. 2 illustrates configurations of a mobile phone 210 and an IP data terminal 220 according to an embodiment of the present invention. The mobile phone 210 includes a radio connector 211, a dialing and speaking function unit 212, an identifier request signal receiver 213, an identifier transmitter 214, and a connection port 215.

The radio connector 211 and the dialing and speaking function unit 212 perform the same functions as those of a conventional mobile phone. The identifier request signal receiver 213 detects an identifier request signal sent from an integrated switch 110, 120 or 130 illustrated in FIG. 1. The identifier transmitter 214 receives the identifier request signal, and then transmits identifier information of the mobile phone 210. The connection port 215 connects the mobile phone 210 with the IP data terminal 220. The connection port 215 can use a wired connecting method or a wireless connecting method. However, the present invention is not limited to a specific connecting method.

The IP data terminal 220 such as a personal digital assistant (PDA) and a notebook computer includes an IP data terminal functional unit 221, a connection port 222, and a silent detector 223. The IP data terminal functional unit 221 performs conventional IP data terminal functions. The connection port 222 is connected with the connection port 215 of the mobile phone 210. The silent detector 223 detects whether the state of the channel used by a mobile phone currently connected to the IP data terminal 220 through the connection port 222 has a silent period. When the silent period is detected, the silent detector 223 transmits information on the silent period to the IP data terminal functional unit 221 through a path 224.

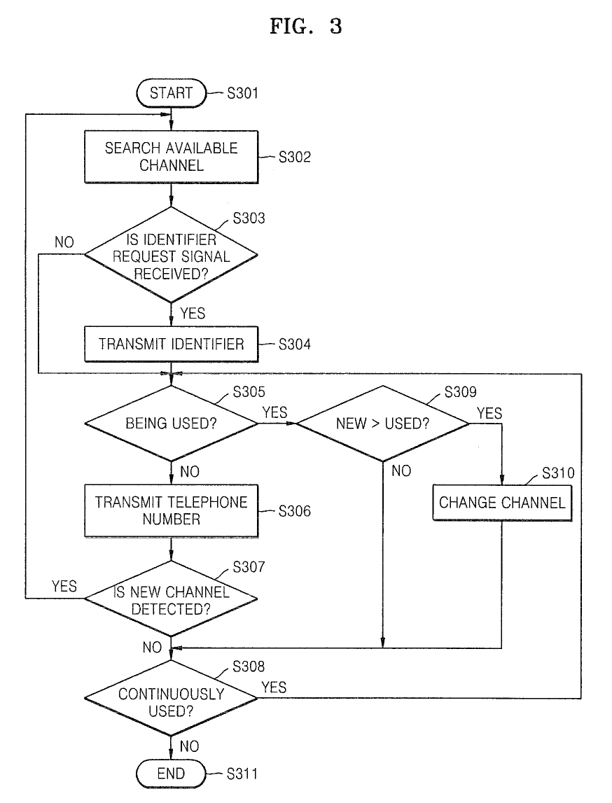

FIG. 3 is a flow chart illustrating the operation of the mobile phone 210 illustrated in FIG. 2 according to an embodiment of the present invention. Referring to FIGS. 2 and 3, support of mobility is initiated in operation S301, and then an available channel is searched in operation S302.

When an available channel exist, the identifier request signal receiver 213 of the mobile phone 210 waits an identifier request signal from an integrated switch 110, 120 and 130 illustrated in FIG. 1 for a predetermined time (for example, 0.5 seconds) in operation S303. The identifier request signal receiver 213 transmits an identifier in operation S304 if the identifier request signal is received within the predetermined time. The identifier request signal receiver 213 determines whether the current channel is being used in operation S305 when the identifier request signal receiver 213 does not receive the identifier request signal within the predetermined time. Specifically, when the mobile phone 210 is being connected with a destination telephone (or being moved), it is determined in operation S305 that the current channel is being used. When the mobile phone 210 starts its operation to initiate connection with a desired destination telephone in a certain integrated switch area, it is determined in operation S305 that the current channel is not being used.

When the identifier request signal receiver 213 determines that the current channel is being used in operation S305, the radio power of the current channel is compared with the radio power of a new channel in operation S309. When it is determined in operation S305 that the current channel is not being used, the telephone number of the destination telephone is transmitted in operation S306.

It is determined whether the mobile phone 210 detects a new channel having a radio power higher than the radio power of the current channel in operation S307. The process is returned to operation S302 when it is determined that the mobile phone 210 detects the new channel. It is determined whether the connecting state of the current channel is maintained continuously in operation S308 when the mobile phone 210 does not detect the new channel. The process is returned to operation S305 when it is determined that the connecting state of the current channel is maintained. The process is finished when it is determined that the connecting state of the current channel is not maintained any more.

When it is determined that the radio power of the new channel is higher than the radio power of the current channel in operation S309, the channel is switched to the new channel in operation S310. The use of the mobile phone 210 is finished in operation S311.

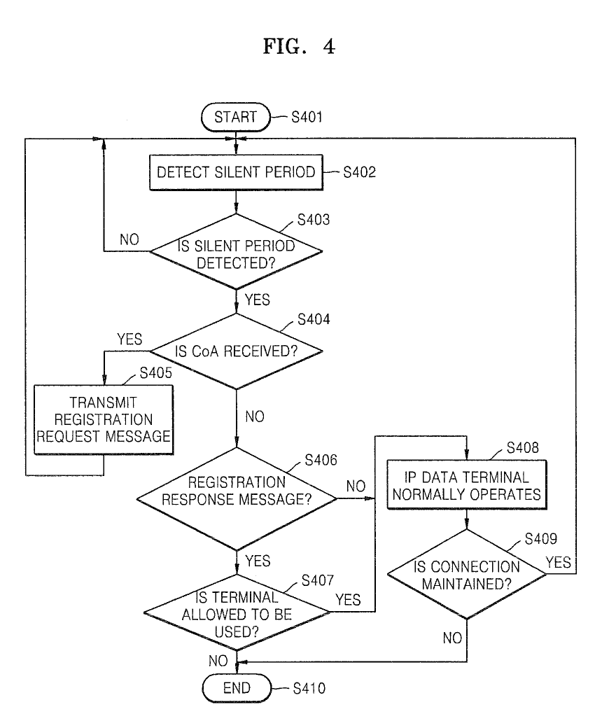

FIG. 4 is a flow chart illustrating the operation of the IP data terminal 220 illustrated in FIG. 2 according to an embodiment of the present invention. The operation of the IP data terminal 220 uses the existing mobile IPv4 (that is, IETF RFC3344). Referring to FIGS. 2 and 4, when the integrated switch 110, 120 or 130 illustrated in FIG. 1 successfully connects with a mobile phone, the integrated switch considers an IP address given in a silent period of the connecting line as a care-off-address (CoA) in mobile IP and transmits the CoA to the IP data terminal 220 during the silent period.

The IP data terminal 220 detects the silent period and performs connection request (registration request) using the CoA which is received during the silent period. The integrated switch searches a visitor list and a neighboring area list thereof and transmits a signal that makes an inquiry of a home agent that the IP data terminal 220 is allowed to be registered through a virtual private network when the IP data terminal 220 is not included in the visitor list and the neighboring area list.

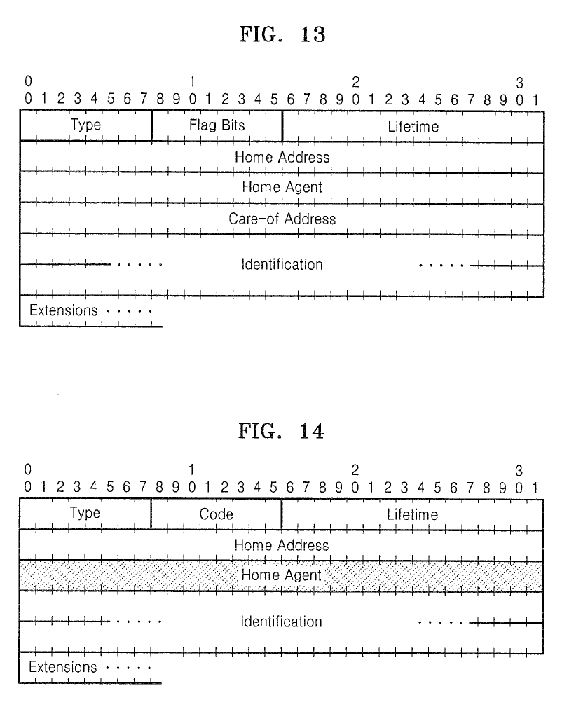

More specifically, the connection port 222 of the IP data terminal 220 is connected with the connection port 215 of the mobile phone 210 in operation S401. The silent detector 223 detects the silent period in operation S402. It is determined whether the silent period is detected in operation S403. The silent detector 223 detects the silent period again in operation S402 when the silent period is not detected in operation S403. When the silent period is detected in operation S403 the CoA sent from the integrated switch is detected during the silent period in operation S404. When the CoA is detected, the IP data terminal 220 transmits a registration request message to the integrated switch in operation S405. After the registration request message is transmitted, the silent detector 223 detects the silent period in operation S402. The registration request message uses the registration request message format of RFC3344 illustrated in FIG. 13.

When the CoA is not detected, it is determined whether information sent from the integrated switch is a registration response message in operation S406. When the information is not the registration response message, the IP data terminal 220 performs a regular operation (that is, an operation of transmitting and receiving IP data) in operation S408. After IP data is transmitted, it is determined whether the connecting state of a currently used data channel is maintained in operation S409.

When the information transmitted from the integrated switch corresponds to the registration response message, it is determined whether the contents of the registration response message are allowed to be used in operation S407. When the contents of the registration response message are not allowed to be used, the process is finished in operation S410. When the contents of the registration response message are allowed to be used, the IP data terminal 220 maintains the regular operating state (that is, the operation of transmitting and receiving IP data) in operation S408. For example, the registration response message uses the registration response message format of RFC3344 illustrated in FIG. 14.

When it is determined that the connecting state of the currently used data channel is maintained in operation S409, the silent period is detected in operation S402. When it is determined that the connecting state of the currently used data channel is not maintained in operation S409, the process is finished in operation S410.

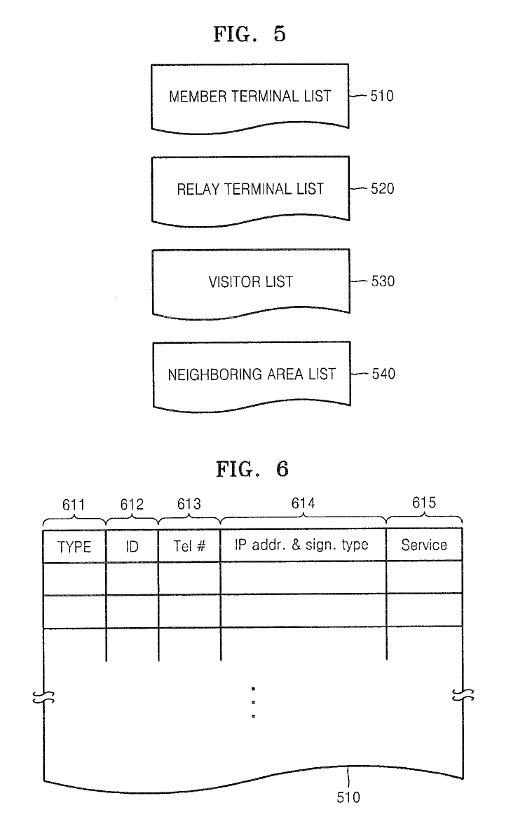

FIG. 5 illustrates lists included in an internal agent of an integrated switch X according to an embodiment of the present invention. In FIG. 5, a neighboring area means an area adjacent to a geographical coverage area of the integrated switch X. For example, the integrated switches 110 and 130 illustrated in FIG. 1 correspond to neighboring area integrated switches of the integrated switch 120 and the integrated switch (not shown) located on the left of the integrated switch 110 illustrated in FIG. 1 is not a neighboring area integrated switch of the integrated switch 120.

Referring to FIG. 5, the lists included in the internal agent of the integrated switch X include a member terminal list 510, a relay terminal list 520, a visitor list 530 and a neighboring area list 540.

The member terminal list 510 corresponds to a list of terminals belongings to the integrated switch X. The relay terminal list 520 is a list of terminals which are belonging to the integrated switch X and being connected with another integrated switch Y. The visitor list 530 is a list of terminals which are connected with the integrated switch X and do not belong to the member terminal list 510. The neighboring area list 540 is a list of terminals which are connected to another integrated switch Z in a neighboring area of the integrated switch X and do not belong to the integrated switch Z. In other words, the neighboring area list of the integrated switch X is a visitor list of the integrated switch Z.

The aforementioned four lists are filled with null in an initial stage.

FIG. 6 illustrates details of the list (510 illustrated in FIG. 5) of terminals belonging to a certain integrated switch according to an embodiment of the present invention. Referring to FIG. 6, reference numeral 611 represents the type of a terminal (wire/wireless/the others), 612 represents identifier information of the terminal, 613 denotes the telephone number of the terminal, 614 denotes the IP address of the terminal and an IP signaling type (IPv4, MIPv4, SIP), and 615 denotes an allowable service type (fixed/mobile/whether to allow simultaneous use of IP).

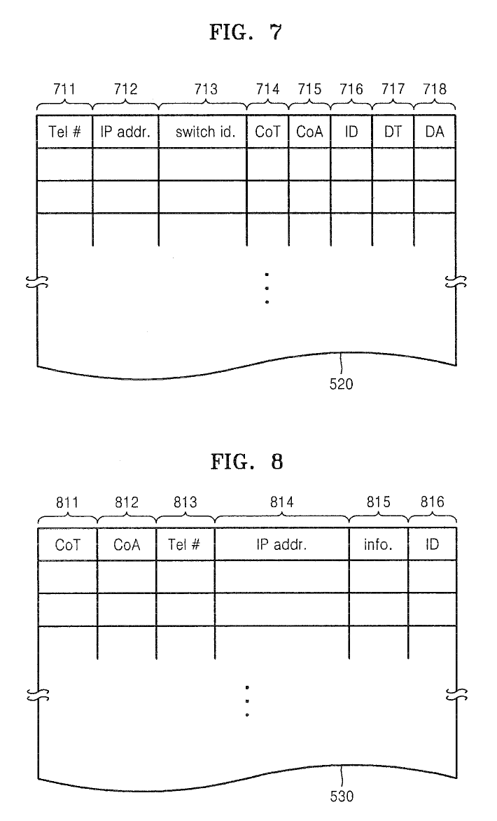

FIG. 7 illustrates details of the relay terminal list 520 illustrated in FIG. 5 according to an embodiment of the present invention. Referring to FIG. 7, reference numeral 711 represents the telephone number of a relay terminal requiring relay, 712 represents an IP address given to the relay terminal, 713 represents a current integrated switch Y to which the relay terminal is connected, 714 represents the telephone number of the integrated switch Y, 715 denotes an IP address given by the integrated switch Y, 716 denotes the identifier of the relay terminal, 717 denotes the phone number of a destination telephone which is being telephone-connected with the relay terminal, and 718 denotes the IP address of a destination IP-connected with the relay terminal.

FIG. 8 illustrates details of the visitor list 530 illustrated in FIG. 5 according to an embodiment of the present invention. Referring to FIG. 8, reference numeral 811 represents a telephone number given to a visitor terminal by an integrated switch, 813 represents the original telephone number of the visitor terminal, 812 represents an IP address given to the visitor terminal by the integrated switch, 814 denotes the original IP address (that is, home address) of the visitor terminal, 815 denotes information on the visitor terminal such as lifetime transmitted from an integrated switch to which the visitor terminal belongs, and 816 denotes an identifier information of the visitor terminal.

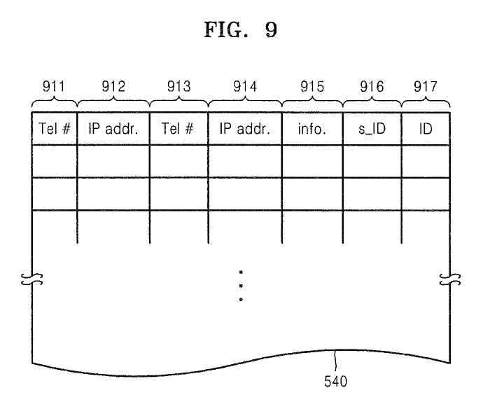

FIG. 9 illustrates details of the neighboring area list 540 illustrated in FIG. 5 according to an embodiment of the present invention. Referring to FIG. 9, reference numeral 911 represents a telephone number given to a visitor terminal of an neighboring integrated switch by the neighboring integrated switch, 913 represents the original telephone number of the visitor terminal, 912 represents an IP address given to the visitor terminal by the neighboring integrated switch, 914 represents the original IP address of the visitor terminal, 915 denotes information on the visitor terminal such as lifetime information transmitted from an integrated switch to which the visitor terminal belongs, 916 denotes identification information of the neighboring integrated switch, and 917 denotes an identifier information of the visitor terminal.

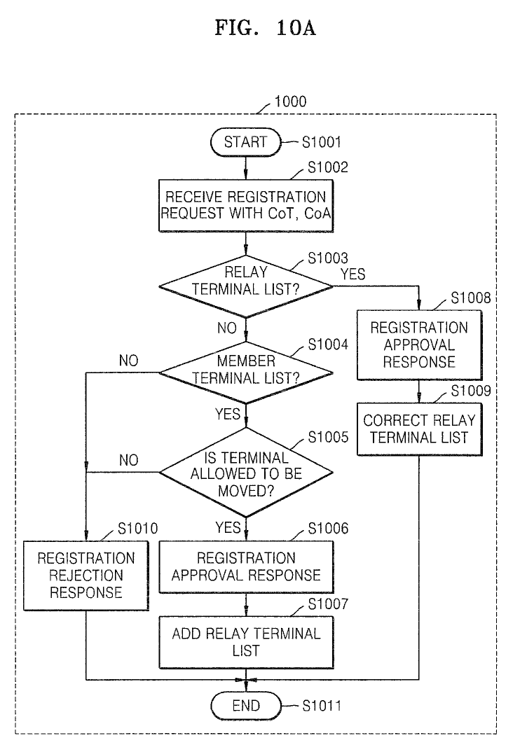

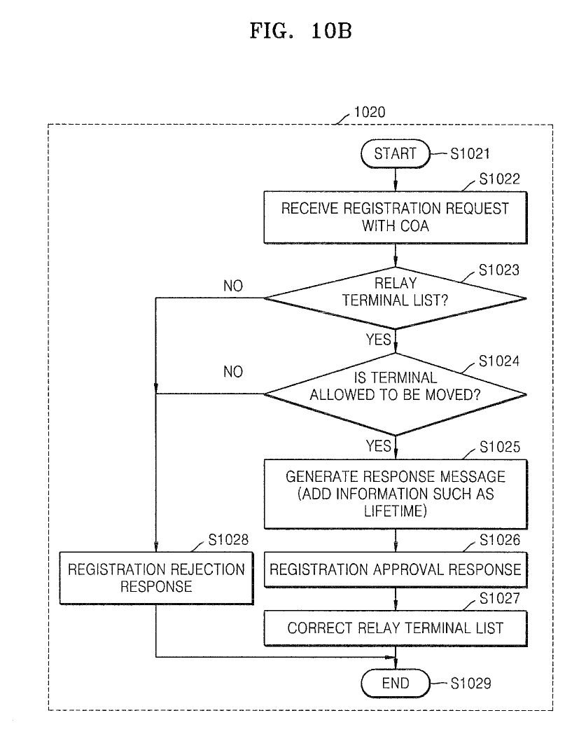

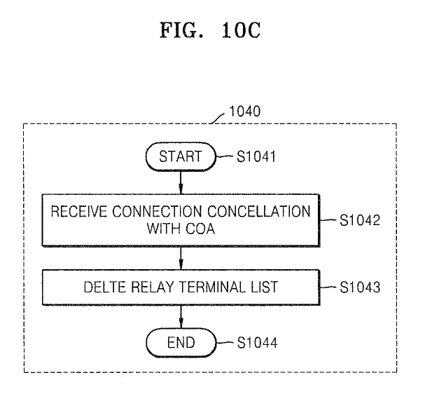

FIGS. 10A, 10B and 10C are flow charts illustrating the operation of an integrated switch (first integrated switch) including a telephone terminal and an IP data terminal which are connected with an integrated switch (second integrated switch) other than the integrated switch and belong to the relay terminal list 520 illustrated in FIG. 5.

FIG. 10A is a flow chart of an operation of providing telephone channel mobility. Referring to FIG. 10A, the operation of providing telephone channel mobility is started in operation S1001. The first integrated switch receives a registration request message including a mobile phone identifier, a telephone number and an IP address for the telephone terminal and the IP data terminal from the second integrated switch in operation S1002. The first integrated switch determines whether the telephone terminal belongs to the relay terminal list illustrated in FIG. 7 in operation S1003. When the telephone terminal belongs to the relay terminal list illustrated in FIG. 7, the first integrated switch sends a registration approval response message including information on the telephone terminal such as lifetime information to the second integrated switch in operation S1008. When the telephone terminal does not belong to the relay terminal list illustrated in FIG. 7, the first integrated switch determines whether the telephone terminal belongs to the member terminal list illustrated in FIGS. 5 and 6 in operation S1004.

When the telephone terminal belongs to the member terminal list, the first integrated switch determines whether to allow the telephone terminal to be moved according to service information illustrated in FIG. 6 in operation S1005. When it is determined that the telephone terminal is allowed to be moved, the first integrated switch sends the registration approval response message including information on the telephone terminal such as lifetime information to the second integrated switch in operation S1006. Then, a list including an integrated switch identifier with respect to the telephone terminal, the telephone number and the IP address of the integrated switch used by the terminal, the telephone number of a destination connected with the telephone terminal and a destination IP address is added to the relay terminal list illustrated in FIG. 7 in operation S1007.

When the telephone terminal does not belong to the member terminal list or the telephone terminal is not allowed to be moved, the second integrated switch transmits a registration rejection response message to the telephone terminal in operation S1010. When it is determined that the telephone terminal belongs to the relay terminal list in operation S1003, the first integrated switch sends the registration approval response message including information on the telephone terminal such as lifetime information to the second integrated switch in operation S1008. The integrated switch identifier with respect to the telephone terminal, the destination telephone number and the destination IP address are corrected in the relay terminal list in operation S1009.

FIG. 10B is a flow chart of an operation of providing IP data terminal mobility. Referring to FIG. 10B, the operation of providing IP data terminal mobility is started in operation S1021. The first integrated switch receives a registration request message including a mobile phone identifier and an IP address for the IP data terminal from the second integrated switch in operation S1022. The first integrated switch determines whether the IP data terminal belongs to the relay terminal list illustrated in FIG. 7 in operation S1023. When the IP data terminal belongs to the relay terminal list illustrated in FIG. 7, the first integrated switch determines whether to allow the IP data terminal to be moved according to service information of the IP data terminal, included in the member terminal list illustrated in FIG. 6, in operation S1024. When the IP data terminal is allowed to be moved, the first integrated switch generates a registration approval response message including information such as lifetime information in operation S1025. The first integrated switch sends the registration approval response message to the second integrated switch in operation S1026. An integrated switch identifier with respect to the IP data terminal and a destination IP address are corrected in the relay terminal list in operation S1027.

When it is determined that the IP data terminal does not belong to the relay terminal list in operation S1023 or when the IP data terminal is not allowed to be moved in operation S1024, the first integrated switch transmits a registration rejection response message to the second integrated switch in operation S1028 and finishes the process in operation S1029.

FIG. 10C is a flow chart of an operation of canceling connection of a terminal belonging to the first integrated switch and the second integrated switch. Referring to FIG. 10C, the first integrated switch receives a connection cancellation message from the second integrated terminal in operation S1042. A list with respect to the terminal is deleted from the relay terminal list illustrated in FIG. 7 in operation S1043.

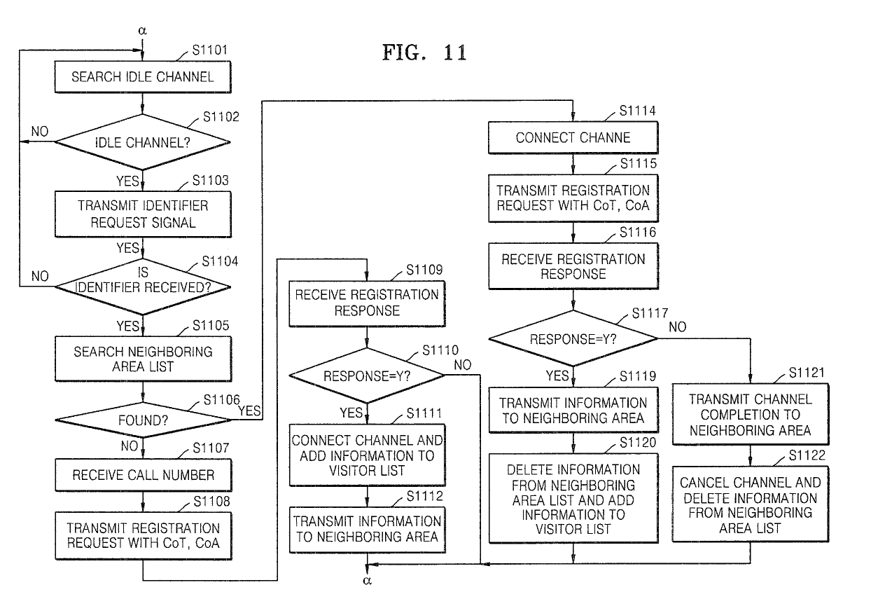

FIG. 11 is a flow chart of an operation of processing a mobility-related message when a telephone terminal that does not belong to an integrated switch is connected to the integrated switch A to be provided with a service. Referring to FIG. 11, the integrated switch A searches a currently available idle channel in operation S1102. When there is no idle channel, the integrated switch A continuously performs the search operation in operation S1103. When the idle channel exists, the integrated switch A transmits an identifier request signal to a mobile phone that might visit the integrated switch A for a predetermined period of time and receives an identifier through a predetermined common air channel in operation S1103. The integrated switch A determines whether the identifier is received in operation S1104. When the identifier is not received, the integrated switch A searches the idle channel in operation S1102. When the identifier is received, the integrated switch A searches the neighboring area list illustrated in FIG. 9 for the received identifier in operation S1105. When the neighboring area list does not include the identifier, the integrated switch A considers the telephone terminal as an initially visiting terminal and receives the telephone number of a destination terminal of the telephone terminal in operation S1107.

After the telephone number is received, the integrated switch A transmits a registration request message including a telephone number and an IP address to be used by the telephone terminal to an integrated switch to which the telephone terminal belongs in operation S1108.

The integrated switch A receives a registration response message from the integrated switch to which the telephone terminal belongs in operation S1109. It is determined whether the telephone terminal is registered from the received registration response message in operation S1110. When the determination result is “Yes”, the channel is connected to the telephone number transmitted from the telephone terminal, and information including the identifier 816, the original telephone number 813 and the original IP address 814 illustrated in FIG. 8 of the telephone terminal, the telephone number 811 and the IP address 815 illustrated in FIG. 8 provided by the integrated switch, and information such as lifetime included in the registration response message is added to the visitor list illustrate in FIG. 8 in operation S1111.

The visitor list information and integrated switch identification information are transmitted to integrated switches of neighboring areas in operation S1112. Then, an available idle channel is detected in operation S1102.

When the determination result is not “Yes” in operation S1110, an available idle channel is searched.

When the neighboring area list includes the identifier 917 illustrated in FIG. 9 in operation S1106, the idle channel searched in the operation S1102 is connected to the telephone terminal in operation S1114. The registration request message including the telephone number and the IP address to be used by the telephone terminal to the integrated switch to which the telephone terminal belongs in operation S1115. Then, the registration response message is received from the integrated switch to which the telephone terminal belongs in operation S1116.

It is determined whether the telephone terminal is registered from the received registration response message in operation S1117. When the determination result is “Yes”, the information including the telephone number and the IP address provided by the integrated switch and information such as lifetime information included in the registration response message are transmitted to neighboring integrated switches in operation S1119.

A list corresponding to the telephone terminal is deleted from the neighboring area list illustrated in FIG. 9 and information on the telephone terminal is added to the visitor list illustrated in FIG. 8 in operation S1120. When the determination result is not “Yes” in the operation S1117, a channel cancellation message is sent to neighboring integrated switches in operation S1121. The channel connected in the operation S1114 is finished and a list corresponding to the telephone terminal is deleted from the neighboring area list in operation S1122. Then, an available idle channel is searched in operation S1102.

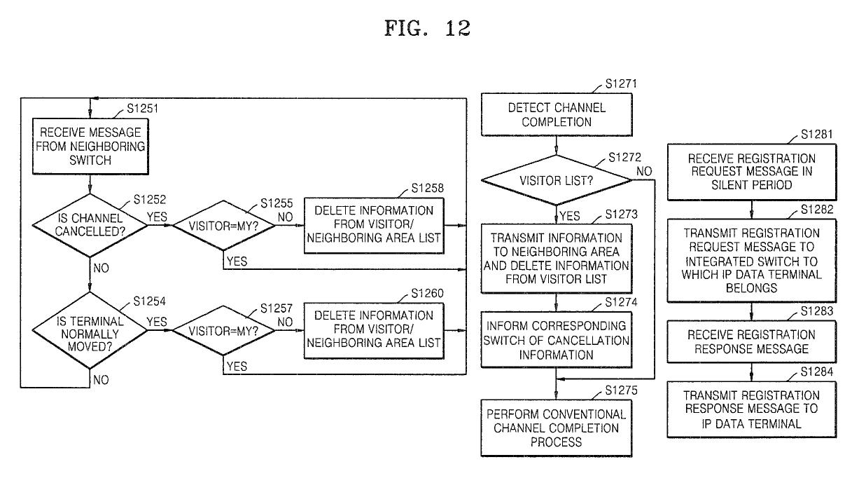

FIG. 12 is a flow chart illustrating an operation of an integrated switch geographically adjacent to an integrated switch A when a telephone terminal and an IP data terminal which do not belong to the integrated switch A are connected to the integrated switch A to receive a service. Referring to FIG. 12, a mobility-related message is received from an integrated switch of a neighboring area in operation S1251. It is determined whether the received mobility-related message corresponds to channel cancellation information for the telephone terminal and the IP data terminal in operation S1252. When the mobility-related message does not correspond to the channel cancellation information, the integrated switch of the neighboring area receives a registration approval response corresponding to a result of a registration response message and determines whether the telephone terminal and the IP data terminal are normally moved in operation S1254.

When the telephone terminal and the IP data terminal are not normally moved, the mobility-related message is received again from the integrated switch of the neighboring area. When the mobility-related message corresponds to the channel cancellation information in operation S1252, it is determined whether a visitor terminal with respect to the mobility-related message belongs to the integrated switch, which receives the mobility-related message in operation S1251, in operation S1255. When the visitor terminal belongs to the integrated switch receiving the mobility-related message, a mobility-related message is received from an integrated switch of a neighboring area. When the visitor terminal does not belong to the integrated switch receiving the message, a list corresponding to the visitor terminal is deleted from the visitor list and the neighboring area list in operation S1258. Then, a mobility-related message is received from an integrated switch of a neighboring areas.

When the telephone terminal and the IP data terminal are normally moved in operation S1254, it is determined whether the visitor terminal with respect to the message belongs to the integrated switch, which receives the message in operation S1251, in operation S1257. When the visitor terminal belongs to the integrated switch receiving the message, a mobility-related message is received from a neighboring integrated switch.

When the visitor terminal does not belong to the integrated switch receiving the message, the list corresponding to the visitor list is deleted from the visitor list, the neighboring area list illustrated in FIG. 9 is searched for the list, and information on the terminal (that is, 911, 912, 915 and 916 of FIG. 9) is corrected into the information, which is received in operation S1251, in operation S1260.

When channel completion for a terminal used in the integrated switch area is detected, it is determined whether the list corresponding to the terminal is included in the visitor list in operation S1272. When the list is not included in the visitor list, a conventional channel completion process (that is, a conventional call completion process) is performed. When the list is included in the visitor list, the list is deleted from the visitor list and channel cancellation information for the terminal is transmitted to an integrated switch of a neighboring area in operation S1273. The integrated switch to which the terminal belongs is informed of the channel cancellation information in operation S1274 and the conventional channel completion process is performed in operation S1275.

FIG. 13 illustrates a format of a registration request message transmitted from an IP data terminal to an integrated switch, which corresponds to IETF RFC3344 format, and FIG. 14 illustrates a format of a registration response message transmitted from an integrated switch to an IP data terminal, which corresponds to IETF RFC3344 format.

As described above, when an IP data terminal and a telephone terminal are moved to a network area having a number system different from that of the network area to which the IP data terminal and the telephone terminal belong, the IP data terminal and the telephone terminal can use the original addresses thereof and be provided with real-time mobility.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of providing services to terminals using an integrated switch, the method comprising:
transmitting an identifier of a telephone terminal of a subscriber in response to an identifier request signal received from the integrated switch and receiving a telephone service from the integrated switch through the telephone terminal;
detecting a silent period from a telephone service channel of the telephone terminal; and
transmitting an IP service registration request message including a care-of-address (CoA) using the silent period of the telephone service channel to the integrated switch, receiving a registration response message including an approval response from the integrated switch, and receiving an IP data terminal service from the integrated switch through a data terminal of the subscriber.

2. The method of claim 1, wherein the transmitting of the identifier of the telephone terminal of the subscriber comprises:
transmitting a connection signal to the integrated switch;
detecting the identifier request signal received from the integrated switch;
transmitting the identifier of the telephone terminal; and
providing dialing and speaking functions to the subscriber through the telephone terminal.

3. The method of claim 1, wherein the transmitting of the IP service registration request message comprises:
connecting the IP data terminal to the telephone terminal;
detecting the silent period from the telephone service channel of the telephone terminal; and
transmitting/receiving IP data of the subscriber through the IP data terminal.

4. A path setting method of an integrated switch for simultaneously providing real-time mobility of an IP address and a telephone number, the path setting method comprising:
receiving a registration request message including a telephone number of a telephone terminal and an IP address of an IP data terminal from a first integrated switch located in a first network area in which the telephone terminal and the IP data terminal are originally located when the telephone terminal and the IP data terminal are moved to a second network area;
determining whether the telephone number of the telephone terminal and the IP address of the IP data terminal are included in an internal list of a second integrated switch located in the second network area; and
providing the telephone service to the telephone terminal by the second integrated switch and providing the IP data service to the IP data terminal in a silent period of a telephone service channel of the telephone terminal when the telephone number of the telephone terminal and the IP address of the IP data terminal both are included in the internal list of the second integrated switch.

5. The path setting method of claim 4, wherein the determining of whether the addresses of the telephone terminal and the IP data terminal are included in the internal list of the second integrated switch comprises determining whether the addresses of the telephone terminal and the IP data terminal are included in one of a member terminal list, a relay terminal list, a visitor list and a neighboring area list included in the internal list of the second integrated switch,
the member terminal list includes a telephone number of a telephone terminal and an IP address of a data terminal which belong to the second integrated switch,
the relay terminal list includes a telephone number of a telephone terminal and an IP address of a data terminal which are not included in the member terminal list and receive a relay service from the second integrated switch,
the visitor list includes a telephone number of a telephone terminal and an IP address of data terminal which receive a service from the second integrated switch and are not included in the member terminal list and the relay terminal list,
and the neighboring area list includes a telephone number of a telephone terminal and an IP address of data terminal which belong to an adjacent integrated switch located in a network area geographically adjacent to the second network area.

6. The path setting method of claim 5, wherein the member terminal list includes the type, identifier information and telephone number of the telephone terminal, an IP address and IP signaling type given to the data terminal, and an allowable service type.

7. The path setting method of claim 5, wherein the allowable service type includes at least one of a fixed service, a mobile service and an IP simultaneous service.

8. The path setting method of claim 5, wherein the relay terminal list includes the telephone number of a telephone terminal corresponding to a target of relay, an IP address given to the data terminal, the identifier of an integrated switch connected with the telephone terminal and the data terminal, the telephone number of the integrated switch, a CoA provided by the integrated switch, the original identifier of the telephone terminal, a destination telephone number and a destination address.

9. The path setting method of claim 5, wherein the visitor list includes a telephone number provided by the adjacent integrated switch to a visitor terminal, a CoA, the telephone number of the visitor terminal, the IP address (home address) of the visitor terminal, information received from an integrated switch to which the visitor terminal belongs, such as lifetime, and the original identifier of the visitor terminal.

10. The path setting method of claim 5, wherein the neighboring area list includes a telephone number provided by the second integrated switch to a visitor terminal, an IP address (CoA), the telephone number of the visitor terminal, the IP address (home address) of the visitor terminal, information received from an integrated switch to which the visitor terminal belongs, such as lifetime, identification information of the adjacent integrated switch and the original identifier of the visitor terminal.
